(19) United States
(12) Patent Application Publication
(10) Pub. No.: US 2026/0112082 A1
(43) Pub. Date: Apr. 23, 2026

(54) ENCODING DATA FOR GENERATING RASTER TILES REPRESENTING A GEOGRAPHIC AREA

(71) Applicant: Mapbox, Inc., Washington, DC (US)

(72) Inventor: Ricky Steven Reusser, Oakland, CA (US)

(21) Appl. No.: 18/922,737

(22) Filed: Oct. 22, 2024

(51) Int. Cl. G06T 11/40; G06F 16/25; G06F 16/29

(52) U.S. Cl. CPC G06T 11/40; G06F 16/258; G06F 16/29

(57) ABSTRACT

A method and system for encoding unstructured geospatial data into structured geospatial data tiles is described. Unstructured geospatial data is parsed it into various data types. For each data type, a data band is generated comprising the parsed unstructured data corresponding to the data type. Data pixels for each data band are then generated, with each data pixel comprising a defined number of bits of the parsed unstructured data. Data block including data pixels of one or more of the data bands are generated. Structured geospatial data tiles are generated using the data blocks and a header identifying the location of each data pixel for each data type in the data blocks within the structured geospatial data tile. The structured geospatial data tile may be configured with a number of bits suited to be decoded by a processing unit of a client device.

### FIELD OF ART

This description relates to generating raster data tiles for mapping, and particularly to encoding geospatial data into a structured data format for generating structured raster data tiles.

### BACKGROUND

Raster data tiles have become instrumental in mapping technology given their ability to represent geospatial information in a highly detailed and comprehensive manner. These tiles are made up of logical layers, with each layer housing diverse data types. The information encompassed within these layers can range from details of physical elevation to heat maps, vegetation density, and more. The availability of such diverse and rich data within each layer of a raster tile can serve a broad spectrum of use-cases—from planning precise paths for unmanned aerial vehicles, to analyzing terrain for urban development, to conducting in-depth climate research.

However, the process of extracting useful insights becomes increasingly challenging when dealing with the unstructured data from which these visualizations are derived. As this data lacks strict organization or systematic arrangement, the creation of efficient and widely usable outputs (e.g., data tiles) becomes complex and challenging. In this respect, there is a need for a system and method that can efficiently manage and package chaotic geospatial data. Thus, a method for encoding geospatial information into manageable and broadly applicable data tiles could significantly improve the processes of data management and processing. Moreover, encoding method could increase the versatility and utility of these geospatial data applications across various industries.

### SUMMARY

In some aspects, the techniques described herein relate to a method for providing a structured data stream including a plurality of structured geospatial data tiles, the method including: accessing geospatial data from one or more network systems; encoding the geospatial data into structured geospatial data tiles by: parsing the geospatial data into a plurality of data types; for each data type of the plurality of data types, generating one or more data bands of a plurality of data bands, each data band including the parsed geospatial data corresponding to the data type, generate data pixels for each data band of the plurality of data bands, each data pixel of a plurality of data pixels including a defined number of bits of the parsed geospatial data, generating a plurality of data blocks, each data block of the plurality of data blocks including data pixels of one or more of the data bands of the plurality of data bands, and generating a plurality of structured geospatial data tiles, each structured geospatial data tile of the plurality of structured geospatial data tiles including one or more of the data blocks and a header identifying a location of each data pixel for each data type in the one or data blocks in the structured geospatial data tile; and providing the plurality of structured geospatial data tiles to a client device as a structured data stream; wherein the client device includes a processing unit configured to generate visualizations of geospatial data tiles using the defined number of bits of the data pixels.

In some aspects, the techniques described herein relate to a method, wherein the defined number of bits is thirty two bits.

In some aspects, the techniques described herein relate to a method, wherein the geospatial data access from the one or more network systems includes unstructured data representing one or more characteristics of an environment represented by the geospatial data.

In some aspects, the techniques described herein relate to a method, wherein each of the one or more characteristics correspond to a data type of the plurality of data types such that each data band includes geospatial information describing a characteristic of the one or more characteristics using a data type of the plurality of data types.

In some aspects, the techniques described herein relate to a method, wherein parsing the geospatial data includes sorting the geospatial data based on a location the geospatial data is collected.

In some aspects, the techniques described herein relate to a method, wherein parsing the geospatial data includes sorting the geospatial data based on a time the geospatial data is collected.

In some aspects, the techniques described herein relate to a method, wherein the plurality of data types in each structured geospatial data tile includes three data types.

In some aspects, the techniques described herein relate to a method, wherein: geospatial data for a first data type of the plurality of data types is encoded using a first fraction of the defined number of bits in each data pixel, and geospatial data for a second data type of the plurality of data types is encoded using a second fraction of the defined number of bits in each data pixel different from the first fraction.

In some aspects, the techniques described herein relate to a method, wherein: geospatial data for a third type of the plurality of data types is encoded using a third fraction of the defined number of bits in each data pixel different from both the first fraction and the second fraction.

In some aspects, the techniques described herein relate to a method, further including rendering each structured geospatial data tile of the plurality of structured geospatial data tiles for visualization on the client device.

In some aspects, the techniques described herein relate to a non-transitory computer-readable storage medium soring computer program instructions for providing a structured data stream including a plurality of structured geospatial data tiles, the computer-program instructions, when executed by one or more processors, causing the one or more processors to: access geospatial data from one or more network systems; encode the geospatial data into structured geospatial data tiles by: parsing the geospatial data into a plurality of data types; for each data type of the plurality of data types, generating one or more data bands of a plurality of data bands, each data band including the parsed geospatial data corresponding to the data type, generate data pixels for each data band of the plurality of data bands, each data pixel of a plurality of data pixels including a defined number of bits of the parsed geospatial data, generating a plurality of data blocks, each data block of the plurality of data blocks including data pixels of one or more of the data bands of the plurality of data bands, and generating a plurality of structured geospatial data tiles, each structured geospatial data tile of the plurality of structured geospatial data tiles including one or more of the data blocks and a header identifying a location of each data pixel for each data type in the one or data blocks in the structured geospatial data tile; and provide the plurality of structured geospatial data tiles to a client device as a structured data stream; wherein the client device includes a processing unit configured to generate visualizations of geospatial data tiles using the defined number of bits of the data pixels.

In some aspects, the techniques described herein relate to a non-transitory computer-readable storage medium, wherein the defined number of bits is thirty two bits.

In some aspects, the techniques described herein relate to a non-transitory computer-readable storage medium, wherein the geospatial data access from the one or more network systems includes unstructured data representing one or more characteristics of an environment represented by the geospatial data.

In some aspects, the techniques described herein relate to a non-transitory computer-readable storage medium, wherein each of the one or more characteristics correspond to a data type of the plurality of data types such that each data band includes geospatial information describing a characteristic of the one or more characteristics using a data type of the plurality of data types.

In some aspects, the techniques described herein relate to a non-transitory computer-readable storage medium, wherein parsing the geospatial data further causes the one or more processors to: sort the geospatial data based on a location the geospatial data is collected.

In some aspects, the techniques described herein relate to a non-transitory computer-readable storage medium, wherein parsing the geospatial data wherein parsing the geospatial data further causes the one or more processors to: sort the geospatial data based on a time the geospatial data is collected.

In some aspects, the techniques described herein relate to a non-transitory computer-readable storage medium, wherein the plurality of data types in each structured geospatial data tile includes three data types.

In some aspects, the techniques described herein relate to a non-transitory computer-readable storage medium, wherein: geospatial data for a first data type of the plurality of data types is encoded using a first fraction of the defined number of bits in each data pixel, and geospatial data for a second data type of the plurality of data types is encoded using a second fraction of the defined number of bits in each data pixel different from the first fraction.

In some aspects, the techniques described herein relate to a non-transitory computer-readable storage medium, wherein: geospatial data for a third type of the plurality of data types is encoded using a third fraction of the defined number of bits in each data pixel different from both the first fraction and the second fraction.

In some aspects, the techniques described herein relate to a system including: one or more processors; a non-transitory computer-readable storage medium soring computer program instructions for providing a structured data stream including a plurality of structured geospatial data tiles, the computer-program instructions, when executed by one or more processors, causing the one or more processors to: access geospatial data from one or more network systems; encode the geospatial data into structured geospatial data tiles by: parsing the geospatial data into a plurality of data types; for each data type of the plurality of data types, generating one or more data bands of a plurality of data bands, each data band including the parsed geospatial data corresponding to the data type, generate data pixels for each data band of the plurality of data bands, each data pixel of a plurality of data pixels including a defined number of bits of the parsed geospatial data, generating a plurality of data blocks, each data block of the plurality of data blocks including data pixels of one or more of the data bands of the plurality of data bands, and generating a plurality of structured geospatial data tiles, each structured geospatial data tile of the plurality of structured geospatial data tiles including one or more of the data blocks and a header identifying a location of each data pixel for each data type in the one or data blocks in the structured geospatial data tile; and provide the plurality of structured geospatial data tiles to a client device as a structured data stream; wherein the client device includes a processing unit configured to generate visualizations of geospatial data tiles using the defined number of bits of the data pixels.

### BRIEF DESCRIPTION OF THE DRAWINGS

FIG. 1 illustrates a system environment the enables providing a structured data stream of geospatial data tiles for a digital map, according to one example embodiment.

FIG. 2 illustrates a client device, according to one embodiment.

FIG. 3 illustrates an external system, according to one example embodiment.

FIG. 4 is a block diagram illustrating an embodiment of the mapping system, according to an example embodiment.

FIG. 5 illustrates the data structure of an encoded map tile.

FIG. 6 is a workflow diagram showing an example workflow for providing a structured data stream comprising a plurality of structured geospatial data tiles, according to one example embodiment.

FIG. 7 is a block diagram that illustrates a computer system upon which embodiments of components of the system environment may be implemented, according to one example embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### I. Introduction

Geospatial raster data tiles are a cornerstone of modern digital mapping techniques. Traditional methods of forming geospatial raster data tiles often grapple with substantial inefficiencies. Traditional tiles are constructed to deliver multi-layered visual depictions of an environment. However, because these visual depictions represent several different data types and densities, the traditional methods of constructing data tiles face many shortcomings. Existing practices often fail to tap into the full depth and breadth of data available (or delve to deeply into the data) resulting in inefficiencies and limiting the power of these data tiles to deliver dynamic and robust geospatial applications streamlined for user-facing applications. For instance, a user looking up the traffic conditions using an application would like data denser than a radio based “traffic report” but does not want information as dense as that collected by the Department of Transportation.

In other words, may of the pitfalls in traditional raster technologies stem from the underlying unstructured, diverse data types that make up these raster data tiles. As the data lacks clear organization, regularity, or a standard format, it presents challenges for meaningful data extraction, usage, and exchange. This lack of structure can result in increased processing times, reduced portability across platforms, and a higher possibility of inconsistencies across different applications - collectively impinging upon operational efficiency.

However, the introduction of a structured data format could potentially revolutionize the way geospatial information is processed and utilized. By going beyond the unstructured realm and encapsulating and encoding raw data within a systematized framework, these data tiles become more digestible and refined. Implementing a well-structured format where each layer, band, and pixel is identified in a header of the data tile can vastly improve data management and processing speed. Consequently, this opens the door for a broader range of applications of the data tiles, increasing their utility and efficiency across various domains.

### II. System Environment & Architecture

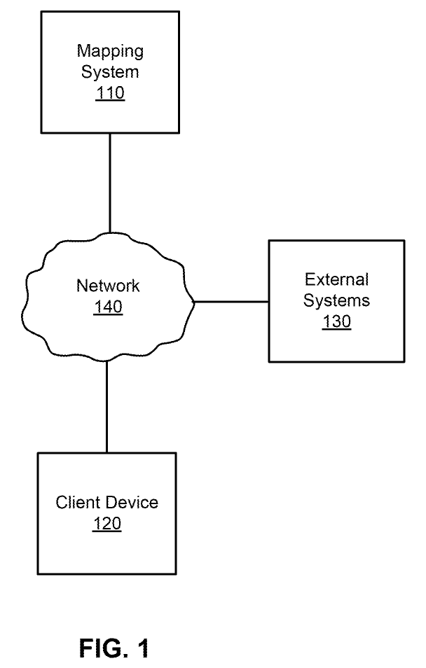

FIG. 1 illustrates a system environment the enables providing a structured data stream of geospatial data tiles for a digital map, according to one example embodiment. In the embodiment shown, the system environment 100 includes a mapping system 110, one or more client devices 120, one or more external system and a network 140. The system environment 100 may include additional or fewer elements and/or the elements may be arranged in a manner different than what is depicted. Moreover, the functionality attributed to one element in the system environment 100 may be performed by one or more of the other elements in the system environment 100. The system environment 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. The components of FIG. 1 are now described in more detail.

The mapping system 110 provides mapping services (e.g., providing structured map data) to client devices 120. In embodiments, the mapping system 110 provides map data to client devices 120 for a variety of purposes, such as to display digital maps for purposes of navigation, ride sharing, or video games (e.g., a mixed reality game). In particular, the mapping system 110 renders map tiles representing respective geographic region that can be used to render digital maps at various scales or resolutions, such as by stitching together the set of rendered map tiles. The map tiles are rendered from corresponding geospatial data that can be used to dynamically render the map tile. The encoded geospatial data of the map tiles include geometric information representing geographic features of a geographic region (e.g., roads, terrain, buildings, etc.) and metadata including associated labels describing characteristics of the geographic region, such as the geographic features. The labels may include text (e.g., geographic features names), symbols or icons (e.g., symbols for different types of geographic features), or any other suitable visual indicator of a map tile characteristic.

The mapping system 110 processes the geographic information and labels of a map tile to render the map tile in a structured data format, as described in more detail below. In some cases, the structured data format can include a static format representing the map tile (e.g., as a JPEG, PNG, or other image file formats) that can be combined with other rendered map tiles to render an overall digital map. In some cases, the structured format of the rendered map tiles may be various image formats, such as JPEG, PNG, or any other image format usable to represent a rendered map tile. Moreover, in some cases, the rendered map tiles can include additional layers of data representing different characteristics (e.g., roads, windspeed, etc.) in the geospatial area of the digital map. Whatever the case, by rendering individual map tiles representing portions of an overall digital map, as opposed to rendering the entire digital map altogether, the mapping system 110 provides for efficient rendering of digital maps that can dynamically adapt to various scenarios (e.g., map scales). After rendering a map tile, the mapping system 110 may provide the rendered map tile to a device rendering a digital map, e.g., on the client device 120. The mapping system 110 may provide the rendered map data tile using an encoded set of structured data, and the client device 120 may render and display the data tile by decoding the encoded set of structured data.

The mapping system 110 may be comprised of any computing device, including but not limited to: servers, racks, workstations, personal computers, general purpose computers, laptops, Internet appliances, wireless devices, wired devices, multi-processor systems, mini-computers, virtual computing instances, and the like. Although FIG. 1 shows a single element, the mapping system 110 broadly represents one or multiple computing devices, such as a server cluster, which may be located in one or more physical locations.

The client device 120 communicates with the mapping system 110 in order to receive map data. The client device 120 may use the map data for a variety of purposes, such as displaying a digital map or providing navigation services. In embodiments the client device 120 requests a set of rendered map tiles from the mapping system 110 for rendering a digital map on a display of the client device. For instance, the client device 120 may request a set of rendered map tiles for rendering a digital map representing a particular geographic region at one or more scales or resolutions. In this case, the client device 120 may receive the set of rendered map tile from the mapping system 110 and stitch together the set of rendered map tiles to render the digital map.

The client device 120 may be any suitable computing device, such as a laptop computer, hand-held computer, wearable computer, cellular or mobile phone, portable digital assistant (PDA), or tablet computer. Although a single client device is depicted in FIG. 1, any number of client devices may be present. The client device 120 may include a GPS receiver that receives signals describing a geographic position of the client device 120 from GPS satellites (e.g., longitude and latitude).

The external system 130 communicates with the mapping system 110 to provide geospatial data to the mapping system 110 via the network 140. The geospatial data, at a high level, describes a geographic area. The geospatial data may describe one or more characteristics about the geographic area. Thus, the mapping system 110 can parse the geospatial data received from the external system 130 to render geospatial data tiles for a digital map of the geographic area.

The external system 130 may be any suitable computing device, such as a laptop computer, hand-held computer, wearable computer, cellular or mobile phone, portable digital assistant (PDA), or tablet computer. The external system 130 may include one or more sensors, measurement systems, etc. to gather data representing the various characteristics in the geographic region. Although an external system device is depicted in FIG. 1, any number of client devices may be present. The external system 130 may include a GPS receiver that receives signals describing a geographic position of the external system 130 from GPS satellites (e.g., longitude and latitude).

The network 140 connects the mapping system 110, the client device 120, and the external system 130. The network 140 may be any suitable communications network for data transmission. In an embodiment such as that illustrated in FIG. 1, the network 140 uses standard communications technologies or protocols and can include the internet. In another embodiment, the entities use custom or dedicated data communications technologies.

### III. Exemplary Systems

### Client Device

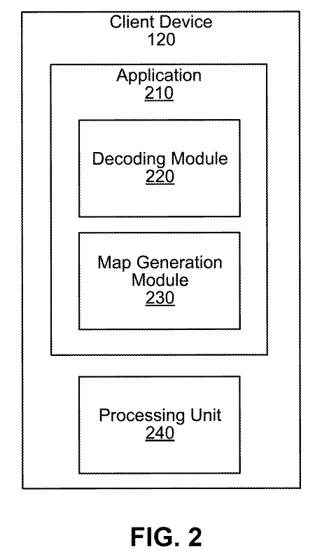

FIG. 2 illustrates a client device, according to one example embodiment. The client device 120 receives map data from the mapping system 110 via a network 140. The client device 120 includes an application 210 and a processing unit 240. As illustrated, the application 210 includes a decoding module 220 and a map generation module 230. In different embodiments, the client device 120 and its components may include different or additional elements than those illustrated in FIG. 2. Furthermore, the functionality may be distributed among the elements in a different manner than described.

The client device 120 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. That hardware, therefore, may execute computer program code using one or more of its processors to perform the functionality attributed to the client device 120 herein.

The client device includes an application 210. The application 210 enables the client device 120 to use map data from the mapping system 110 for a variety of applications (e.g., displaying maps, providing navigation instructions, transportation, augmented reality, product delivery, etc.). The application 210 may additionally include hardware and/or modules for collecting and computing information for the generation of maps or map data. For instance, the application 210 may include hardware for obtaining global position information of the client device 120 and displaying map tile information about the geographic area surrounding the location of the client device 120.

The application 210 includes a decoding module 220 and a map generation module 230. The application 210 employs the decoding module 220 to decode encoded map data information received from the mapping system 110 via the network 140. Generally, the encoded map data represents one or more data structures forming one or map tiles for a digital map representing a geographic area. Thus, the decoding module 220 employs the map generation module 230 to generate a map of a geographic area using the decoded map data. For instance, the map generation module 230 may input the decoded map data, generate map tiles, and stitch the map tiles together to form a map of the geographic region represented by the encoded map data.

The client device 120 includes a processing unit 240. The processing unit 240 is a hardware unit (e.g., a CPU, a GPU, etc.) configured for generating a map from the decoded map data. That is, the processing unit 240 inputs the decoded map data, processes the decoded map data, and renders the map tiles to generate the map of the geographic region. In some examples, the processing unit is configured to process data using data structures having, e.g., 16, 32, 64, 128, 256, etc. bits. In turn, the encoded data may be configured to have the number of bits of the processing unit 240 when decoded, and/or the decoding module 220 may be configured to decode the encoded map data such that the decoded data is structured to have the number of bits of the processing unit 240. Thus, in some configurations, the decoding module 230 can determine the structure of the decoded data (e.g., number of bits) that matches the processing unit 240. Of course, in some configurations, the mapping system 110 may encode data using a data structure that, when decoded, has the appropriate data structure (e.g., number of bits) for the processing unit 240.

In an embodiment, the application 210 obtains electronic mapping functions through an integrated software development kit (SDK) or an application programming interface (API) associated with the mapping system 110. In this case, the SDK or API which may implement functional calls, callbacks, methods or other programmatic means for contacting the server computer to obtain map tiles, map tile labels, layer data, or other data that can form the basis of visually rendering a map as part of the application. As an example, the application 210 may identify a set of map tiles needed to render a particular geographic region (e.g., defined by a set of geographic coordinates) and request corresponding rendered map tiles from the mapping system 110. Additionally, the integrated SDK and/or API may be employed to update and maintain the decoding module 220 with the appropriate algorithms to decode incoming encoded map data.

### External System

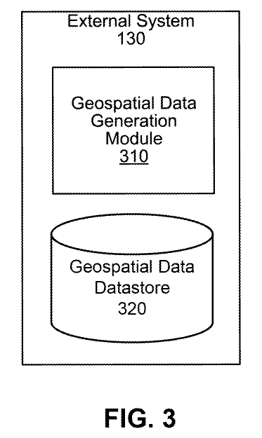

FIG. 3 illustrates an external system, according to one example embodiment. The external system 130 receives generates geospatial data representing a geographic area and provides the geospatial data to the mapping system 110 via a network 140 (or the mapping system 110 may access the geospatial data). The external system 130 includes a geospatial data generation module 310 and a geospatial data datastore 320. In different embodiments, the external system 130 and its components may include different or additional elements than those illustrated in FIG. 3. Furthermore, the functionality may be distributed among the elements in a different manner than described.

The external system 130 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. That hardware, therefore, may execute computer program code using one or more of its processors to perform the functionality attributed to the external system 130 herein.

The external system 130 includes a geospatial data generation module 310 (the “generation module”). The generation module 310 generates geospatial data representing a geographic area. Geospatial data describes one or more characteristics of a geographic region, and simultaneously provides a quantification of each characteristic at individual, localized points in the geographic region. To illustrate, geospatial data describing a geographic region may be elevation data for that geographic region. In this case, the geospatial data quantifies the elevation of the geographic region at various coordinates within the geographic region. The density of geospatial data can be, e.g., as small as inch by inch or as large as, e.g., 50 kilometers by 50 kilometers (or larger), depending on the data set.

The generation module 310 may include various hardware to generate the geospatial data. For example, the external system may include e.g., cameras, geolocation units (e.g., GPS), and sensors (e.g., accelerometers, inertial measurement units, etc.) that take measurements of the real-world environment in the geographic area. The geospatial data generated by the generation module 310 may be unstructured (e.g., raw sensor data), semi-structured (e.g., labelled sensor data), or structured (e.g., temporally parsed, labelled sensor data), depending on the configuration of the external system 130. Moreover, the data type generated by the generation module 310 may be different for different characteristics. For instance, wind data may have a different data type than temperature data. The external system 130 can process the measurements, or provide the information to the mapping system 110 for processing, to aid in generating an map tiles in a structured data format.

The external system 130 may store geospatial data in the geospatial data datastore 320. The geospatial data may be the geospatial data generated by the generation module 310 or accessed from some other external system. In some cases, the geospatial datastore may be known libraries of geospatial data such as road networks, weather maps, etc. Whatever the case, the external system 130 generates and or stores geospatial data representing one or more characteristics of a geographic region that may be utilized by the mapping system in providing a structured data stream of structured data tiles for a digital map of a geographic area.

### Mapping System

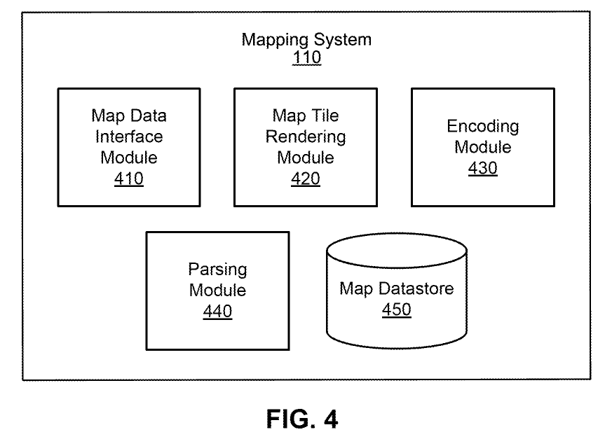

FIG. 4 is a block diagram illustrating an embodiment of the mapping system, according to an example embodiment. The mapping system 110 includes a map data interface module 410 (“interface module” 410), a map tile rendering module 420 (“rendering module” 420), an encoding module 430, a parsing module 440, and a map datastore 450. In different embodiments, the mapping system 110 and its components may include different or additional elements than those illustrated in FIG. 4. Furthermore, the functionality may be distributed among the elements in a different manner than described.

The mapping system 110 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. That hardware, therefore, may execute computer program code using one or more of its processors to perform the functionality attributed to the mapping system 110 herein.

In the embodiment shown, the mapping system 110 includes an interface module 410. The interface module 410 communicates with (1) client devices 120 and/or external systems 130 to provide mapping services, (2) the rendering module 420 to render digital map tiles and digital maps, e.g., for display on the client device 120, and (3) the encoding module 430 to encode the rendered digital map tiles and digital maps.

The interface module 410 provides map data services to one or more computing systems (e.g., the client device 120). In particular, the interface module 410 receives requests for map data describing a geographic region, such as requests for a set of rendered map tiles that can be used to render a digital map representing the geographic region. The request may include a request for one or more characteristics (or data types) of the geographic region (e.g., weather, elevation, traffic, etc.) and the request may indicate one or more scales (e.g., total area displayed) or resolutions (e.g., data density) for the requested digital map. In this case, the interface module 410 may request map tiles from the rendering module 420 and encoding module 430 that comport with the request for the geographic region. Responsive to receiving the request for tiles, the interface module 410 may provide the tiles to a requesting system or device. The tiles may be encoded into a data structure as described hereinbelow. The interface module 410 may receive a request for map data from various sources, such as another component of the mapping system 110 or from a map application 210 on the client device 120. The interface module 410 may provide various interfaces to facilitate communication between the mapping system 110 and other computing systems, such as user interfaces, application programming interfaces (APIs), Software Development Kits (SDKs), and any other suitable interface.

The rendering module 420 renders map tiles that can be used to render digital maps of a geographic area using geospatial information describing the geographic area in the system environment 100. As described above, the rendered map tiles may have different sizes, scales, and resolution. So, for instance, the rendering module 420 may render a single tile including geospatial data representing a city or may render a 10 by 10 grid of tiles representing the city. Additionally, the rendered data tiles may include information representing one or more characteristics (or data types) of the geographic region. For example, the rendered data tiles may describe e.g., traffic conditions for a road network, wind speeds and directions, elevations, temperatures, etc., for the geographic area represented by the rendered data tiles. The information representing the one or more characteristics may be at different resolutions. For example, each rendered data tile may include 1, 10, 100, 1000, etc. points representing the characteristic. For example, a rendered data tile may include 10 or 100 points representing the wind direction and speed of the portion of the geographic region represented by the data tile.

The encoding module 430 encodes rendered map tiles using a structured data format. The structured data format allows devices receiving the structured format to decode the data tiles and display them on the requesting devices as raster data tiles. In an embodiment, the structured data format includes one or more logical layers. Each logical layer describes a characteristic of the geographic area. For example, one logical layer may describe “temperature,” while another logical layer may describe “elevation,” in the region represented by the data tile. Each logical layer includes bands of raster data. A band of raster data may include scalar data, vector data, or some other type of data. Each band of data includes a number of pixels, where each pixel is a fixed thirty-two bits of data (or some other fixed number of bits). In various examples, each data type include in a data band may use the same or different number of bits of the fixed thirty-two bits of data (e.g., one thirty-two bit integer, two sixteen-bit integers, or fur eight-bit integers).

So, as an example, a map tile may represent the “weather” of a geographic region. To do so, the map tile includes logical layers of “temperature,” “wind,” and “imagery.” Each logical layer includes bands of data representing the characteristics (or data type) of its logical layer. Thus, in this case, the logical layer for temperature may include may include three data bands including, e.g., (1) scalar representations of temperature in the region, (2) vector representation of wind speed and direction, and (3) visual pixels corresponding to geospatial area for the temperature and wind (e.g., a 4D vector representing an RGBA pixel).

Additionally, the encoding module 430 may encode a rendered map tile into a data structure using the structured data format. The data structure includes a header and one or more data blocks. The header is a data object that identifies the logical layers, the data bands making up that logical layer, and identifies the data blocks corresponding to the data bands for the logical layer. In effect, the metadata header provides a “map” to the data structure storing the geospatial information of the map tile.

As described above, data bands are encoded into data blocks. Therefore, when encoded, each data block includes one or more bands of geospatial data encoded in the structured data format. Each data block may include data bands corresponding to a single logical layer or different logical layer depending on the amount and types of data encoded. For example, one data block may have data bands corresponding to two logical layers, while another data block may have data corresponding to a single logical layer. Thus, overall, each data block includes some number of data bands representing one or more characteristics corresponding to the logical layer of a map tile. The data block includes data from the data bands representing the portion of the geographic area represented by the data tile. Overall, the data structure representing the rendered map tile allows for one or more characteristics of the geographic area to be displayed as a raster data tile on a client device.

Moreover, the encoding module 430 can encode data bands into data blocks such that geospatial information is stored and/or transmitted within the environment efficiently. For instance, the encoding module 430 can manipulate the position and placement of pixels in the data blocks such that those data blocks adhere to various system constraints (e.g., size, length, etc.). To illustrate, the encoding module may apply byte offsets to pixels representing various data bands when generating data blocks including those pixels. Byte offsets refer to the offset of data sections relative to the start of a file, measured in bytes. This means that the module is may write data wherever it likes in the file as long as the “byte offset” which references the information correctly points to the start of that data section.

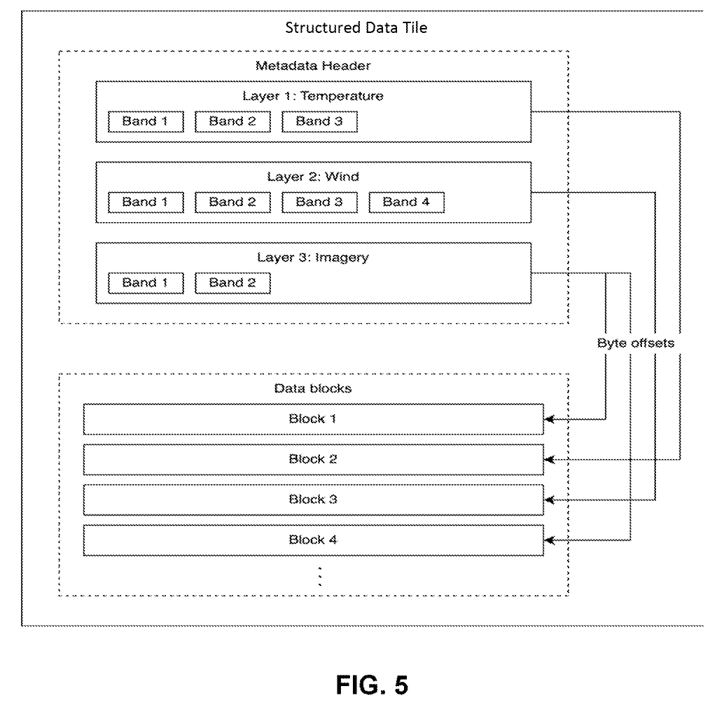

As a visual example, FIG. 5 illustrates the data structure of an encoded map tile. In this example, the map tile includes logical layers representing temperature, wind, and imagery. The temperature layer includes three data bands, the wind layer includes four data bands, and imagery layer includes two data bands. As described above, the bands for each characteristics include geospatial information having different data types (e.g., scalar, vector, imagery). The encoding system encodes the data bands of the temperature layer into block two, the data bands of the wind layer into block 3, and the data bands of the imagery layer into blocks 1 and 4. The map tile includes a header that identifies and locates the logical layers, their bands, and the corresponding data blocks including the data bands for each logical layer.

Returning to FIG. 4, the mapping system 110 includes a parsing module 440. The parsing module 440 can parse received or accessed geospatial data, as needed. Parsing the geospatial data allows the mapping system 110 to use the received or accessed geospatial data in rendering and encoding data tiles. Parsing the incoming geospatial data separates the incoming data such that data can be rendered and encoded into map tiles. For instance, parsing incoming data may separate incoming geospatial data by time, location, density, characteristic, etc. Moreover, the mapping system 110 can parse multiple streams of incoming data using different or the same criteria, depending on the configuration of the mapping system 110. Thus, at a high level, the mapping system receives geospatial information (e.g. from external systems) 130 and parses that geospatial data into different data types.

To illustrate, consider an example where the system environment includes external systems 130 collecting “weather” data throughout the state of California. That is, the external systems measure, quantify, and store wind speed and direction, temperature, rainfall, and air quality. Each of these types of data is generated and stored in a different manner. For instance, some are real-time measurements while some are hourly measurements, and some have a high density while others have a low density. Because of the disparate nature of the measurements, generating coherent data tiles using the unstructured data is challenging. Accordingly, the mapping system 110 employs the parsing module 440 to access and parse the measurements such that they are employable by the encoding module. For instance, the parsing module 440 may parse the data such that is sorted by geographic area (e.g., by county) and reflects similar time periods. In this manner, the accessed data is parsed and sorted in a manner such that the mapping system 110 can, e.g., render and encode tiles representing different counties in California at different time periods.

The mapping system 110 further includes a map datastore 450 that stores map data. The stored map data can be source data and or digital map data.

Source data is raw digital map data that is obtained, downloaded or received from a variety of sources (e.g., external systems 130). The raw digital map data may include satellite images, digital street data, building data, place data or terrain data. Example sources include National Aeronautics and Space Administration (NASA), United States Geological Survey (USGS), and DigitalGlobe. The digital map source data may be updated at any suitable interval and may be stored for any amount of time. Once obtained or received, source data stored in the map datastore 450 can be used by the mapping system 110 to generate map tiles encoded using a structured data format (e.g., parsed for encoding into a map tile).

Digital map data is information representing map tiles. The digital map data may be derived from source data or may be rendered by the rendering module 420. In embodiments, the mapping system 110 processes and organizes source data as a plurality of map tiles with corresponding sets of map labels or other style data used to impose different display styles for rendering the map tiles. Digital map data stored in the map datastore 450 may be updated at any suitable interval.

### IV. Exemplary Process Flows

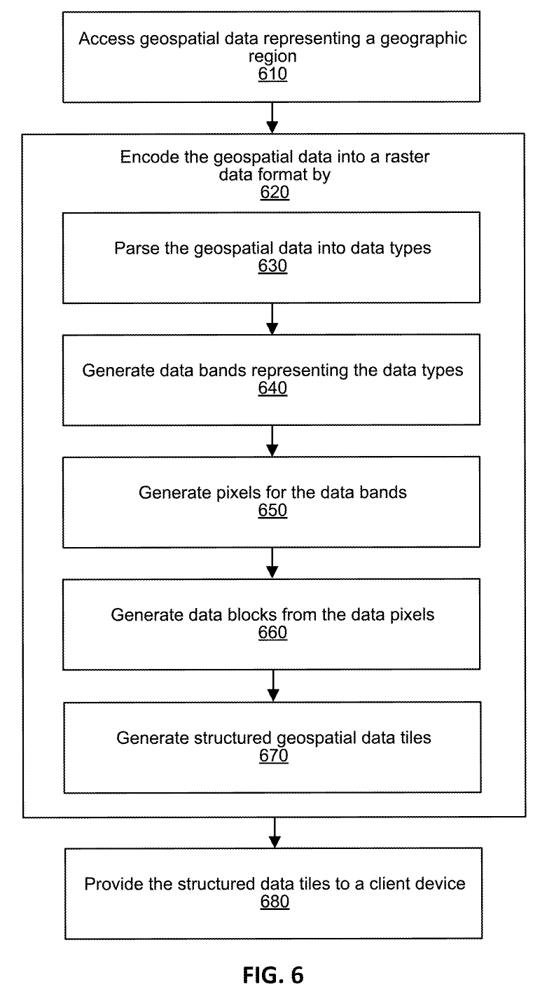

FIG. 6 is a workflow diagram showing an example workflow for providing a structured data stream comprising a plurality of structured geospatial data tiles, according to one example embodiment. In the illustrated workflow, additional or fewer steps may be included, and the steps may occur in a different order. Moreover, one or more of the steps may be omitted or repeated.

In the workflow, one or more client devices (e.g., client device 120), one or more external systems (e.g., external system 130), and a mapping system (e.g. mapping system 110) that communicate with one another in a system environment (e.g., environment 100). The client device is, e.g., a mobile device operated by a user in an environment. The user may execute an application (e.g., application 210) on the client device to access and interact with raster data tiles representing the environment. The external systems generate geospatial information representing the environment that may be used in the raster data tiles. The mapping system accesses the geospatial information representing the environment and encodes that information into raster data tiles. The raster data tiles may be encoded using a structured data format such that, when requested from the client device, the mapping system may provide the structured data stream of structured geospatial data tiles.

To do so, the mapping system accesses 610 geospatial information representing the environment (e.g., from an external system). In an example, the geospatial information is unstructured data (e.g., raw weather data or imagery), although, in some configurations the accessed information may be structured in some way (e.g., binned by position, time, etc.).

The mapping system encodes 620 the unstructured geospatial data into structured geospatial data tiles.

To encode the data tiles, the mapping system parses 630 the unstructured (or structured) geospatial data into a plurality of data types. For instance, the mapping system may take ingest raw weather data and output structured data representing wind, temperature, and air quality. The structured data may be, e.g., position and time localized. That is, the structured data representing wind may represent similar positions and time periods as the structured data representing wind and air quality. In effect, parsing the unstructured geospatial data into structured data normalizes the data for encoding into structured map tiles.

The mapping system generates 640 data bands representing the parsed, unstructured data of each data type (e.g., generates logical layers having data bands representing geospatial information corresponding to that logical layer). For example, the mapping system generates data bands representing the wind speed and direction, data bands representing the air quality, and data bands representing the temperature.

The mapping system generates 650 data pixels for each data band. Thus, each data band may include one or more pixels depending on the amount of geospatial information in the data band. In an example, each data pixel is, e.g., 32 bits. At a higher level, each data pixel corresponds to the number of bits of a processing unit of the client device rendering the data tile.

The mapping system generates 660 data blocks including the data pixels representing the data bands for each data type. Each data block may have bits from one or more data bands, and each data block may have bits from data bands of one or more data types.

The mapping system generates 670 structured data tiles using the data blocks. Each structured data tile includes a header. The header is a data structure representing the data types (e.g., logical layers), data bands, data blocks of the structured data tile. The header also indicates a position of each pixel for each data band in the data blocks. Thus, the header identifies the position of the geospatial information associated with each data type in the data blocks.

The mapping system provides 680 the structured data tiles to a client device as a structured data stream.

The client device receives the structured data stream and decodes the structured map tiles. Notably, the client device includes a processing unit configured to manipulate data 32-bit data structures, and the data pixels of the structured map tiles are 32 bits.

### V. Computer Diagram

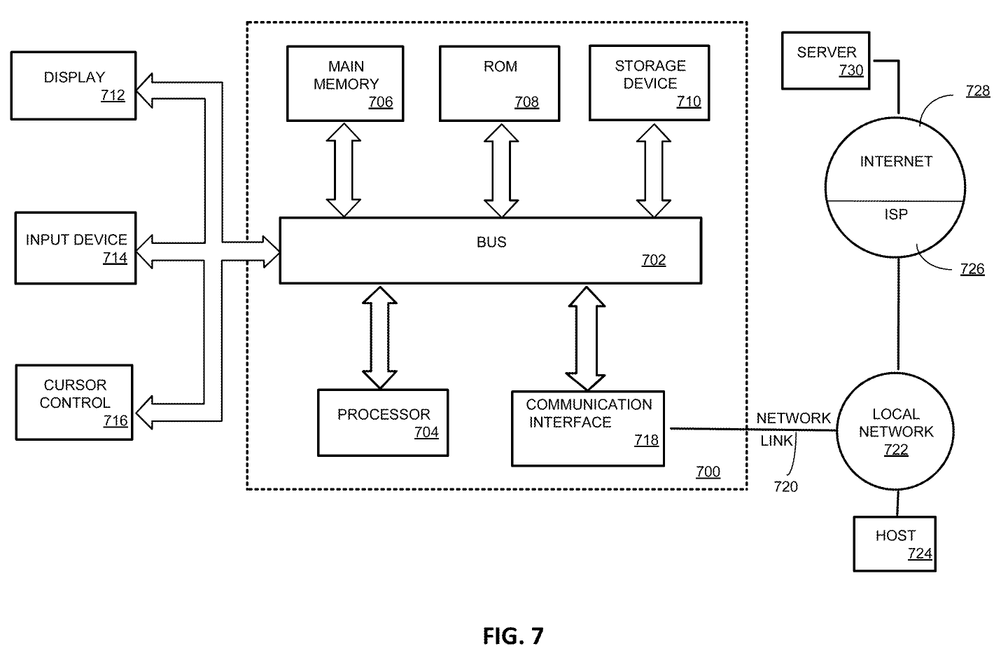

FIG. 7 is a block diagram that illustrates a computer system 700 upon which embodiments of components of the system environment 100 may be implemented. Computer system 700 includes a bus 702 or other communication mechanism for communicating information, and a hardware processor 704 coupled with bus 702 for processing information. Hardware processor 704 may be, for example, a general-purpose microprocessor.

Example computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as an LCD screen, LED screen, or touch screen, for displaying information to a computer user. An input device 714, which may include alphanumeric and other keys, buttons, a mouse, a touchscreen, or other input elements is coupled to bus 702 for communicating information and command selections to processor 704. In some embodiments, the computer system 700 may also include a cursor control 716, such as a mouse, a trackball, or cursor direction keys for communicating direction information and command selections to processor 704 and for controlling cursor movement on display 712. The cursor control 716 typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term "storage media" as used herein refers to any non-transitory media that store data and instructions that cause a machine to operation in a specific fashion. Such storage media may comprise non-volatile media and volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic, radio, or light waves, such as those generated during radio-wave and infra-red data communications, such as WI-Fl, 3G, 4G, BLUETOOTH, or wireless communications following any other wireless networking standard.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the "Internet" 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and stored in storage device 710, or other non-volatile storage for later execution.

### VI. Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein, any reference to “one embodiment” or “an embodiment” means that a particular element, label, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components is present unless it is obvious that it is meant otherwise.

Where values are described as “approximate” or “substantially” (or their derivatives), such values should be construed as accurate +/- 10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for providing a structured data stream comprising a plurality of structured geospatial data tiles, the method comprising:
accessing geospatial data from one or more network systems;
encoding the geospatial data into structured geospatial data tiles by:
parsing the geospatial data into a plurality of data types;
for each data type of the plurality of data types, generating one or more data bands of a plurality of data bands, each data band comprising the parsed geospatial data corresponding to the data type,
generate data pixels for each data band of the plurality of data bands, each data pixel of a plurality of data pixels comprising a defined number of bits of the parsed geospatial data,
generating a plurality of data blocks, each data block of the plurality of data blocks comprising data pixels of one or more of the data bands of the plurality of data bands, and
generating a plurality of structured geospatial data tiles, each structured geospatial data tile of the plurality of structured geospatial data tiles comprising one or more of the data blocks and a header identifying a location of each data pixel for each data type in the one or data blocks in the structured geospatial data tile; and
providing the plurality of structured geospatial data tiles to a client device as a structured data stream;
wherein the client device comprises a processing unit configured to generate visualizations of geospatial data tiles using the defined number of bits of the data pixels.

2. The method of claim 1, wherein the defined number of bits is thirty two bits.

3. The method of claim 1, wherein the geospatial data access from the one or more network systems comprises unstructured data representing one or more characteristics of an environment represented by the geospatial data.

4. The method of claim 3, wherein each of the one or more characteristics correspond to a data type of the plurality of data types such that each data band comprises geospatial information describing a characteristic of the one or more characteristics using a data type of the plurality of data types.

5. The method of claim 1, wherein parsing the geospatial data comprises sorting the geospatial data based on a location the geospatial data is collected.

6. The method of claim 1, wherein parsing the geospatial data comprises sorting the geospatial data based on a time the geospatial data is collected.

7. The method of claim 1, wherein the plurality of data types in each structured geospatial data tile comprises three data types.

8. The method of claim 7, wherein:
geospatial data for a first data type of the plurality of data types is encoded using a first fraction of the defined number of bits in each data pixel, and
geospatial data for a second data type of the plurality of data types is encoded using a second fraction of the defined number of bits in each data pixel different from the first fraction.

9. The method of claim 8, wherein:
geospatial data for a third type of the plurality of data types is encoded using a third fraction of the defined number of bits in each data pixel different from both the first fraction and the second fraction.

10. The method of claim 1, further comprising rendering each structured geospatial data tile of the plurality of structured geospatial data tiles for visualization on the client device.

11. A non-transitory computer-readable storage medium soring computer program instructions for providing a structured data stream comprising a plurality of structured geospatial data tiles, the computer-program instructions, when executed by one or more processors, causing the one or more processors to:
access geospatial data from one or more network systems;
encode the geospatial data into structured geospatial data tiles by:
parsing the geospatial data into a plurality of data types;
for each data type of the plurality of data types, generating one or more data bands of a plurality of data bands, each data band comprising the parsed geospatial data corresponding to the data type,
generate data pixels for each data band of the plurality of data bands, each data pixel of a plurality of data pixels comprising a defined number of bits of the parsed geospatial data,
generating a plurality of data blocks, each data block of the plurality of data blocks comprising data pixels of one or more of the data bands of the plurality of data bands, and
generating a plurality of structured geospatial data tiles, each structured geospatial data tile of the plurality of structured geospatial data tiles comprising one or more of the data blocks and a header identifying a location of each data pixel for each data type in the one or data blocks in the structured geospatial data tile; and
provide the plurality of structured geospatial data tiles to a client device as a structured data stream;
wherein the client device comprises a processing unit configured to generate visualizations of geospatial data tiles using the defined number of bits of the data pixels.

12. The non-transitory computer-readable storage medium of claim 11, wherein the defined number of bits is thirty two bits.

13. The non-transitory computer-readable storage medium of claim 11, wherein the geospatial data access from the one or more network systems comprises unstructured data representing one or more characteristics of an environment represented by the geospatial data.

14. The non-transitory computer-readable storage medium of claim 3, wherein each of the one or more characteristics correspond to a data type of the plurality of data types such that each data band comprises geospatial information describing a characteristic of the one or more characteristics using a data type of the plurality of data types.

15. The non-transitory computer-readable storage medium of claim 11, wherein parsing the geospatial data further causes the one or more processors to:
sort the geospatial data based on a location the geospatial data is collected.

16. The non-transitory computer-readable storage medium of claim 11, wherein parsing the geospatial data wherein parsing the geospatial data further causes the one or more processors to:
sort the geospatial data based on a time the geospatial data is collected.

17. The non-transitory computer-readable storage medium of claim 11, wherein the plurality of data types in each structured geospatial data tile comprises three data types.

18. The non-transitory computer-readable storage medium of claim 17, wherein:
geospatial data for a first data type of the plurality of data types is encoded using a first fraction of the defined number of bits in each data pixel, and
geospatial data for a second data type of the plurality of data types is encoded using a second fraction of the defined number of bits in each data pixel different from the first fraction.

19. The non-transitory computer-readable storage medium of claim 18, wherein:
geospatial data for a third type of the plurality of data types is encoded using a third fraction of the defined number of bits in each data pixel different from both the first fraction and the second fraction.

20. A system comprising:
one or more processors;
a non-transitory computer-readable storage medium soring computer program instructions for providing a structured data stream comprising a plurality of structured geospatial data tiles, the computer-program instructions, when executed by one or more processors, causing the one or more processors to:
access geospatial data from one or more network systems;
encode the geospatial data into structured geospatial data tiles by:
parsing the geospatial data into a plurality of data types;
for each data type of the plurality of data types, generating one or more data bands of a plurality of data bands, each data band comprising the parsed geospatial data corresponding to the data type,
generate data pixels for each data band of the plurality of data bands, each data pixel of a plurality of data pixels comprising a defined number of bits of the parsed geospatial data,
generating a plurality of data blocks, each data block of the plurality of data blocks comprising data pixels of one or more of the data bands of the plurality of data bands, and
generating a plurality of structured geospatial data tiles, each structured geospatial data tile of the plurality of structured geospatial data tiles comprising one or more of the data blocks and a header identifying a location of each data pixel for each data type in the one or data blocks in the structured geospatial data tile; and
provide the plurality of structured geospatial data tiles to a client device as a structured data stream;
wherein the client device comprises a processing unit configured to generate visualizations of geospatial data tiles using the defined number of bits of the data pixels.
